(19) United States
(12) Patent Application Publication
(10) Pub. No.: US 2008/0094842 A1
(43) Pub. Date: Apr. 24, 2008

(54) Three dimensional effect lamp assembly

(75) Inventors: Robert Lee King, Seymour, IN (US); David Egly, Columbus, IN (US); Brant Potter, Columbus, IN (US)

Correspondence Address: OSRAM SYLVANIA INC, 100 ENDICOTT STREET, DANVERS, MA, 01923, US

(73) Assignee: VALEO SYLVANIA LLC, SEYMOUR, IN (US)

(21) Appl. No.: 11/786,231

(22) Filed: Apr. 11, 2007

Related U.S. Application Data
(60) Provisional application No. 60/853,877, filed on Oct. 24, 2006.

(51) Int. Cl. F21V 7/00

(52) U.S. Cl. 362/297

(57) ABSTRACT

A lamp assembly with a thin actual dimension providing an image of greater apparent depth may be formed from a light source, reflector and a partially reflective and partially transmissive lens. The mirrored surface is oriented axially to face a field to be illuminated. A partially light reflective and partially light transmissive lens having a first surface faces the reflector. The lens is offset from the mirrored surface, thereby defining a cavity intermediate the reflector and the lens. The mirrored surface and the first surface of the lens are smoothly bowed with respect of one to the other. At least one LED (light emitting diode) light source capable of emitting visible light, is positioned near the cavity and oriented to direct light into the cavity intermediate the reflector and the lens. Because of the bowing, the multiple reflected images are offset inducing an optical illusion of depth.

### CROSS-REFERENCE TO RELATED APPLICATIONS

Not Applicable

The Applicants hereby claim the benefit of their provisional application Ser. No. 60/853,877 filed Oct. 24, 2006 for Three Dimensional Effect Lamp Assembly.

### BACKGROUND OF THE INVENTION

1. Field of the Invention

The invention relates to electric lamps and particularly to automotive lamps. More particularly the invention is concerned with an electric automotive lamp with a three dimensional image.

2. Description of the Related Art Including Information Disclosed Under 37 CFR 1.97 and 1.98

Exterior automotive lamps commonly have reflective shells that direct the emitted light in a desired direction and pattern. These shells give depth to the lamp image, allowing styling and increased image size. The shells however have physical depth that must be accommodated in the adjacent engine compartment, trunk or other region of the vehicle. It would be convenient if a lamp could be formed that provided a deep visual image; while in fact little actual depth was needed.

Exterior automotive lamps and bumpers frequently are highly stylized to distinguish one vehicle from another particularly where they are otherwise aerodynamically similar. The illuminated jewel look of a reflector and lens cover can catch a viewer's eye. It is however mechanically convenient to place lamps within the bumper area, but that can conflict with the designed bumper look, particularly in a full chrome bumper. The jeweled or colored look of the lamp then detracts from the solid sweep of the chrome bumper. There is then a need for a lamp that cosmetically blends with a chrome bumper.

### BRIEF SUMMARY OF THE INVENTION

A lamp assembly with a thin actual dimension providing an image of greater apparent depth may be formed from a light source, reflector and a partially reflective and partially transmissive lens. The mirrored surface is oriented axially to face a field to be illuminated. The reflector includes a perimeter. A partially light reflective and partially light transmissive lens having a first surface faces the reflector. The lens is offset from the mirrored surface, thereby defining a cavity intermediate the reflector and the lens. The mirrored surface and the first surface of the lens are smoothly bowed with respect of one to the other. At least one LED (light emitting diode) light source capable of emitting visible light, is positioned near the cavity and oriented to direct light into the cavity intermediate the reflector and the lens. The lens has a second surface facing the field to be illuminated. The first surface reflects more than four percent of incident visible light directly from the LED light source and transmits more than four percent of incident directly from the LED light source.

### BRIEF DESCRIPTION OF THE SEVERAL VIEWS OF THE DRAWINGS

FIG. 1 shows a schematic side cross sectional view of an automotive lamp with a reflector bowed forward providing a three dimensional image.

FIG. 2 shows a schematic side cross sectional view of an alternative automotive lamp.

FIG. 3 shows a schematic side cross sectional view of an alternative automotive lamp providing a three dimensional image.

FIG. 4 shows a front view of the projected image of an automotive lamp providing a three dimensional image.

FIG. 5 shows a schematic side cross sectional view of an alternative automotive lamp providing a three dimensional image.

FIG. 6 shows a schematic side cross sectional view of an alternative automotive lamp providing a three dimensional image.

### DETAILED DESCRIPTION OF THE INVENTION

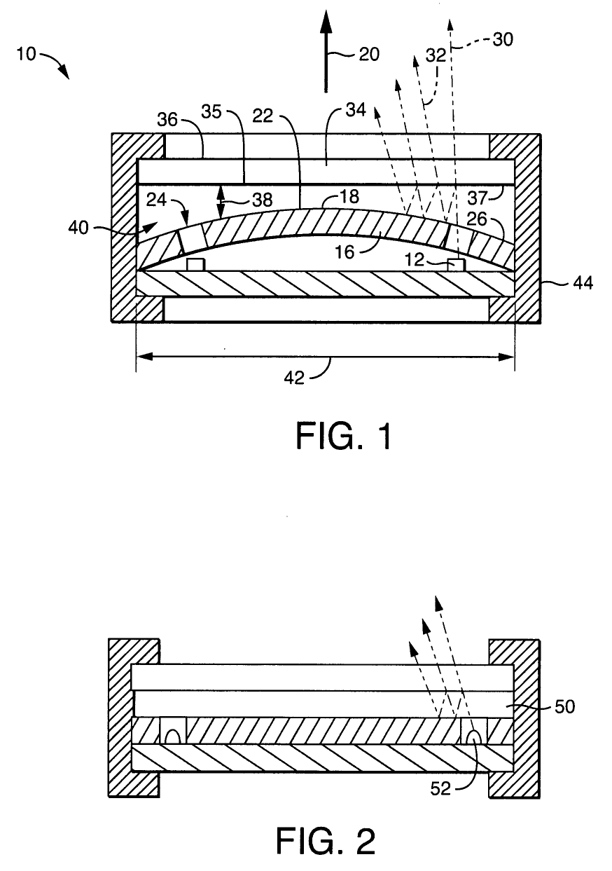

FIG. 1 shows a schematic cross sectional view of an automotive lamp assembly 10 providing a three dimensional image. The lamp assembly 10 includes at least one light source 12, a reflector 16 and a partially reflective lens 34.

The lamp assembly 10 includes at least one light source 12, a reflector 16 and a partially reflective lens 34. While the assembly 10 may be constructed with any light source 12, it is preferred to keep the assembly 10 as axially thin as possible by using a small image light source 12 such as small incandescent filament lamp, a small arc discharge lamp or most preferably a small (5 millimeter diameter or less), LED (light emitting diode) light source 12. The light source 12 has a least image diameter, being the least measurement transverse to the image projected towards a field to be illuminated. The light source 12 may be a white source or a colored source. The light source(s) 12 may be appropriately mounted on a printed circuit board or similar frame that is then brought into registration with the reflector 16 and lens 34 by known methods. Alternatively the light source(s) 12 may be mounted directly on the rear the reflector 16. Electrical connections for the light source(s) 12 may be appropriately formed on the support frame, if any, on the reflector rear, by connection wires or by other known methods.

The reflector 16 has a front surface 18 facing axially 20 towards a field to be illuminated. The reflector 16 includes a mirrored surface 22, which may be the front surface 18, or a similarly oriented surface facing the field to be illuminated. The reflector 16 may be flat, bowed in (rearward), bowed out (forward), faceted or otherwise formed with reflection altering features. The preferred reflector 16 is slightly bowed outwards (forward) from the reflector perimeter 26 to the reflector center, for example as a section of a spherical surface. In one embodiment, the reflector 16 was formed as an 8 centimeter square with a front reflective surface. The square was bowed-outwards as a section of a 254 centimeter radius spherical surface.

The preferred reflector 16 has a plurality of narrow through passages 24 formed around the reflector perimeter 26. Alternatively, the reflector 16 may be formed with a similar plurality of recesses. A plurality of light sources 12, preferably LEDs are respectively positioned, relative to the through passages 24 (or recesses), to emit light around the perimeter 26 of the reflector 16 and near the front surface 18 of the reflector 16. It is understood the through passages may be positioned anywhere along the reflector 16 surface depending on the pattern to be formed. The LEDs may be positioned behind the reflector 16 to shine through the respective through passages 24. The LEDs may alternatively be positioned in the through passages 24, or recesses to emit light from the through passages 24 or recesses. The LEDs may also be positioned to extend through the through passages 24 to emit light in front of the front surface 18, but near the front surface 18 of the reflector 16. The reflector 16 and light sources 12 then provide a series of first images 30 projected axially toward the field to be illuminated around the perimeter 26 of the reflector 16.

The small through passages 24 combined with LEDs mounted behind the reflector 16 to shine through the through passages 24 to create small light images (first images 30) directed toward the field to be illuminated. With small lumen light sources 12, it may be important to maximize light arriving in the field to be illuminated. Directing the initial light emission from the light source(s) 12 directly to the field to be illuminated substantially enhances the illumination of the field. Secondary reflected images 32 then supplement the first images 30. It is believed to be more difficult to start with less luminous, secondary images 32 to achieve proper total final field illumination.

Positioned axially outwards from the reflector 16, and spaced slightly away from the reflector 16 is a lens 34. The lens 34 is designed to be partially light reflective and partially light transmissive. It is understood that a clear lens has an inherent reflectivity of about 4 percent. The lens 34 prescribed here has a reflectivity greater than the inherent 4 percent reflectivity and preferably reflects fifty percent (50%) of light incident at 90 degrees, and correspondingly transmits fifty percent (50%) percent of light incident at 90 degrees. Reflection of from 5% to 95% (or transmission from 95% to 5%) is understood to be possible. Absorption of light by the lens 34 is ignored in these calculations. The lens 34 has a first surface 35 facing the reflector 16, and a second surface 36 facing the field to be illuminated. The lens 34 may be flat or curved. The lens 34 is generally transparent (clear), and is not a diffusion type lens 34. The lens 34 may be colored. For compactness, it is preferred that the reflector 16 and lens 34 both be roughly parallel to each other, albeit bowed one to the other, and offset slightly one from the other by a distance 38. The lens 34 is preferably sized to substantially span the entire axially projected image of the reflector 16 to thereby intercept most if not all of the light from the light source 12 or light sources 12 projected through, adjacent or reflected from the reflector 16. It is understood the lens 34 may have a smaller transverse span than the reflector 16 to provide a partially formed three-dimensional image. Alternatively, the lens 34 may have a greater transverse span than the reflector 16 to assure interception of most if not all of the light transmitted from the reflector 16. The lens 34 is preferably offset from the reflective surface of the reflector 16 by a distance 38 that is equal to or greater than the least image diameter for the light source 12. The reflector 16 and the offset lens 34 then define a cavity 40 intermediate the reflector 16 and the partially reflective lens 34. The light source(s) 12 are oriented to illuminate the partially reflective lens 34. The lens 34 has a second surface facing the field to be illuminated. The lens 34 is constructed to be at least partially reflecting and partially transmissive of the light from the light source 12 or from the reflector 16. It is known that a clear lens of glass or plastic normally reflects small amount of the incident light, about four percent of the incident light. The lens 34 here is formed to reflect more than this natural (inherent) degree of reflection. The lens 34 for example may be metallized, silvered, aluminized, or have an interference coated layer 37 to create a partially reflective and partially transmissive (“half mirror”) lens 34. An appropriate protective coating may be further applied to the reflective surface to prevent oxidation or other deterioration of the reflective and transmissive coating as is known in the art. The relative ratio of reflection to transmission may be tuned for desired effects. For example the lens 34 may reflect from five to ninety-five percent of the incident light, and correspondingly transmit from ninety-five to five percent of incident light. Absorbed light is discounted here and not counted in this calculation. In a true half silver lens 34, fifty percent of incident visible light arriving at 90 degrees directly from the light source 12 is reflected and fifty percent of incident arriving directly from the light source 12 is transmitted.

The at least one light source 12 is positioned to direct light into the cavity 36 intermediate the reflector 16 and the partially reflective lens 34. Light can then pass from the light source 12 through the defined through passage, from the light source 12 retained in a reflector 16 recess or from a light source 12 retained in the passage 26; into the cavity 40 to be partial transmitted by the lens 34 (forming a first image 30), and partially reflected by the lens 34 back to the reflector 16 to be in turn reflected by the reflector 16 back to the lens 34 and again partially transmitted by the lens 34 (forming a second image 32) and partially reflected, and so on for the generation of further multiple images. The resulting plurality of images 30, 32 etc. array in patterns that appear to a viewer to be curved, swirled or otherwise give a three dimensional effect. When the reflector 16 is spherically bowed outwards, the series of source 12 images from the perimeter 26 light sources 12 line up with sequential increasing axially transverse offsets, resulting in an optical illusion resembling the interior of a three dimensional bowl that may appear to be as deep or deeper than the transaxial dimension 42 of the reflector 16 or the lens 34. While the lamp assembly 10 may then be a centimeter or less in actual depth, (lens front to lamp support back) the optical apparent depth is substantially greater.

A housing 44 may be used to enclose the light source(s) 12, the light source support, if any, the reflector 16, and partially reflective lens 34 to provide appropriate electrical and mechanical attachments for coupling the assembly 10 to a vehicle. Vehicle lamp housings typically are weather sealed, frequently adjustable for aiming, and include plug electrical connections. The particular housing and coupling structures to be used with the light source, reflector and lens assembly described here are considered to be a matter of design choice, for which numerous structures and methods may be chosen from.

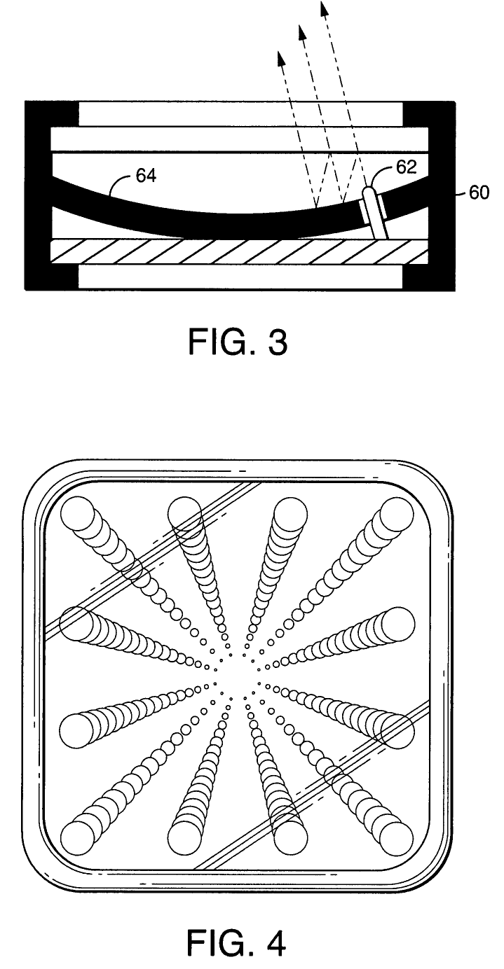

FIG. 2 shows a schematic side cross sectional view of an alternative automotive lamp with a flat reflector 52 and LED light source 52 mounted in a through passage 54 formed in the reflector 56. FIG. 3 shows a schematic side cross sectional view of an alternative automotive lamp providing a three dimensional image with a rearwardly bowed reflector 60, with an LED light source 62 mounted forward of the reflective surface 64. FIG. 4 shows a front view of the projected image of an automotive lamp providing a three dimensional image, of the type from FIG. 1. The half silvered lens provides a mirrored surface facing the exterior when the light source is in an off state, and transmits illuminating light having multiple images of the light source when the light source is in an on state. While not in operation the front lens is effectively a full mirror providing a fully silvered or reflective chrome image. The lens face can then be placed in a chrome housing, such as a vehicle bumper and visually disappear when in the light source is off. When light source is on, the light multiply reflects and passes forward through the lens thereby emerging from the silver or chrome surrounding, providing the deep multiple image illusion. Similarly, while the lamp may have only a small actual depth, such as two or three centimeters, the transverse dimension may be ten or more centimeters, and yet when illuminated the lamp may visually appear to have an illusional depth as great or greater than the actual transverse dimension.

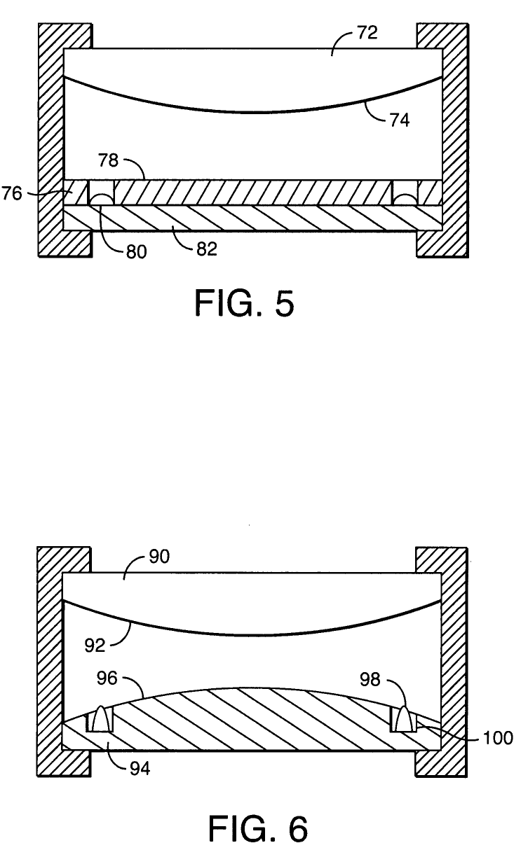

FIG. 5 shows a schematic side cross sectional view of an alternative automotive lamp providing a three dimensional image. It is only necessary that reflective surface be bowed with respect to the partially reflective surface of the lens. FIG. 5 shows a lens 72 with a partially reflective surface 74 bowed towards a reflector 76 with a flat reflective surface 78. Such a construction enables the LED light source 80 supported on a base board 82 to be registered and closely nested in through passages formed in the reflector 76. FIG. 6 shows a schematic side cross sectional view of a further alternative automotive lamp providing a three dimensional image. The partially transmissive lens 90 may have a bowed surface 92, and the reflector 94 may also have a bowed surface 96. The LED light source 98 may also be mounted in a recess 100 formed in the reflector 94. In the examples shown in FIGS. 1, 3, 5 and 6 the bowing of the lens or the reflector, as the case may be, may be in the reverse direction.

While there have been shown and described what are at present considered to be the preferred embodiments of the invention, it will be apparent to those skilled in the art that various changes and modifications can be made herein without departing from the scope of the invention defined by the appended claims.

What is claimed is:

1. A lamp assembly comprising:
a reflector having a mirrored surface oriented axially to face a field to be illuminated, the reflector including a perimeter;
a partially light reflective and partially light transmissive lens having a first surface facing the reflector, the lens further being offset from the mirrored surface, thereby defining a cavity intermediate the reflector and the lens, the mirrored surface and the first surface of the lens being smoothly bowed with respect of one to the other;
at least one LED (light emitting diode) light source capable of emitting visible light, positioned near the cavity and oriented to direct light into the cavity intermediate the reflector and the lens;
the lens having a second surface facing the field to be illuminated, the first surface reflecting more than four percent of incident visible light directly from the LED light source and transmitting more than four percent of incident directly from the LED light source.

2. The lamp assembly in claim 1, wherein the reflector is a flat mirror.

3. The lamp assembly in claim 1, wherein the reflector is bowed outwards.

4. The lamp assembly in claim 1, wherein the reflector is bowed inwards.

5. The lamp assembly in claim 1, wherein the lens is a flat lens.

6. The lamp assembly in claim 1, wherein the lens is bowed outwards.

7. The lamp assembly in claim 1, wherein the lens is bowed inwards.

8. The lamp assembly in claim 1, wherein the lens substantially transaxially spans the entire reflector.

9. The lamp assembly in claim 1, wherein the reflective surface of the lens is offset from the reflector by at least the least diameter of the axially projected image of the LED light source.

10. The lamp assembly in claim 1, wherein the lens reflects half of the incident light from the LED light source.

11. The lamp assembly in claim 1, wherein the lens transmits approximately half of light incident at 90 degrees, and reflects approximately half of light incident at 90 degrees.

12. The lamp assembly in claim 1, wherein the LED light source is positioned intermediate the reflector and the lens.

13. The lamp assembly in claim 1, wherein the reflector includes a recess and the LED light source is positioned in the recess and oriented to direct light toward the lens.

14. The lamp assembly in claim 1, wherein the reflector includes a through passage and the LED light source is positioned in the through passage and oriented to direct light toward the lens.

15. The lamp assembly in claim 1, wherein the reflector includes a light transmissive passage and the light source is positioned to direct light through the light transmissive passage towards the lens.

16. The lamp in claim 1, wherein the half silvered lens provides a mirrored surface facing the exterior when the light source is in an off state, and transmits illuminating light having multiple images of the light source when the light source is in an on state.
